(19) United States
(12) Patent Application Publication
(10) Pub. No.: US 2007/0263804 A1
(43) Pub. Date: Nov. 15, 2007

(54) TELEPHONE WITH ABILITY TO COMMUNICATE WITH MOBILE PHONES

(75) Inventors: Cheng-Shing Lai, Taipei County (TW); Guo-Qing Tang, Nanjing (CN); Jian Shen, Nanjing (CN)

Correspondence Address: WPAT, PC, 7225 BEVERLY ST., ANNANDALE, VA, 22003, US

(73) Assignee: INVENTEC APPLIANCES CORP., Taipei County (TW)

(21) Appl. No.: 11/692,810

(22) Filed: Mar. 28, 2007

(30) Foreign Application Priority Data
May 9, 2006 (TW) 095116352

(51) Int. Cl. H04M 11/00

(52) U.S. Cl. 379/93.05

(57) ABSTRACT

The present invention relates to a PSTN telephone, which is adapted to a public switched telephone network (PSTN) and is capable of communicating with a mobile phone embedded with a wireless module by a wireless manner, which comprises: a power source, capable of providing power to the telephone; a microprocessor, capable of controlling and managing electrical signals of the PSTN telephone; a keypad, capable of dialing; a telephone transceiver, further comprising a microphone, capable of receiving vocal signals of a user, and a loudspeaker, capable of amplifying vocal signals received by the telephone; a wireless module, coupled to the microprocessor, capable of matching to the wireless module of the mobile phone for enabling vocal signals to be transmitted between the same and the wireless module of the mobile phone.

### FIELD OF THE INVENTION

The present invention relates to a telephone capable of receiving incoming calls of a mobile phone, and more particularly, to a telephone embedded with a wireless module, which is adapted to a public switched telephone network (PSTN) and is capable of wirelessly communicating with a bluetooth module embedded in a mobile phone through the wireless module thereof so that incoming calls/messages transmitted from the network used by the mobile phone and those transmitted from the PSTN can be integrated and received by the use of the aforesaid PSTN telephone or its extensions.

### BACKGROUND OF THE INVENTION

In recent years, with the development and popularity in Bluetooth wireless technology along with the maturing of relating technologies, Bluetooth compatibility has gradually become essential for modern electrical devices, such as mobile phones, notebook computers, personal digital assistants (PDAs), and so on. As bluetooth modules are mass-produced, the price of each bluetooth module is dropping consistently that it is acceptable for most people.

Conventionally, the bluetooth module embedded in a mobile phone can only match to only one bluetooth earpiece so as to use the earpiece for communication. However, while a user is proceeding with a vocal communication in a wireless manner by the use of the aforesaid bluetooth earpiece, he/she is vulnerable to electromagnetic radiation that is harmful to human body. In addition, it is more than likely that when a person is situated in a specific surrounding, such as at home, or in one's office, he/she might place one's mobile phone casually at any location without remembering that the mobile phone is operating in mute/vibration mode. Therefore, it is possible for the person to miss an important phone call as the muted mobile phone is unable to make itself noticeable to the person. Hence, it is in need of a PSTN telephone with ability to communicate with the mobile phone.

### SUMMARY OF THE INVENTION

In view of the disadvantages of prior art, the primary object of the present invention is to provide a PSTN telephone, adapted to a public switched telephone network (PSTN) while being enabled to communicate with a mobile phone, which is substantially the PSTN telephone embedded with a wireless module capable of interfacing with a bluetooth module of the mobile phone so as to perform a vocal data exchange operation therebetween, thereby, incoming calls/messages transmitted from the network used by the mobile phone and those transmitted from the PSTN can be integrated and received by the use of the aforesaid PSTN telephone or any of its extensions, and thus those incoming calls/messages will not be missed as one is failing to locate one's mobile phone.

Another object of the invention is to provide a PSTN telephone capable of enabling a person to use the PSTN telephone and any of its extension for receiving any incoming call of one's mobile phone, by which the person is prevented from contacting to the high electromagnetic wave during the instance of transmitting/receiving and thus the health of the person is well protected.

To achieve the above objects, the present invention provides a PSTN telephone capable of receiving incoming calls of a mobile phone, being adapted to a public switched telephone network (PSTN) while being enabled to pair with a mobile phone having a wireless module embedded therein for performing a vocal data exchange therebetween, which is comprised of:
a power source, capable of providing power to the PSTN telephone;
a microprocessor, capable of controlling and managing electrical signals of the PSTN telephone;
a keypad, capable of dialing;
a telephone transceiver, further comprising:
   a microphone, capable of receiving vocal signals of a user; and
   a loudspeaker, capable of amplifying vocal signals received by the PSTN telephone; and
a wireless module, coupled to the microprocessor, capable of matching to the wireless module of the mobile phone for enabling vocal signals to be transmitted between the same and the wireless module of the mobile phone.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram illustrating an architecture of a PSTN telephone capable of enabling a person to use the PSTN telephone and any of its extension for receiving any incoming call of one's mobile phone according to the present invention.

FIG. 2 is a function block diagram of a PSTN phone according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

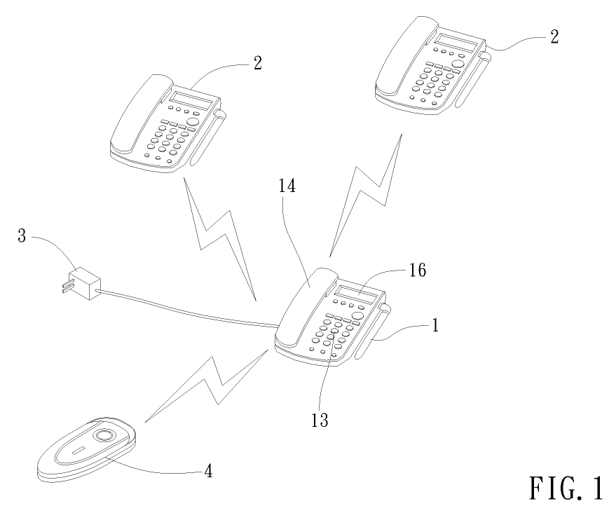

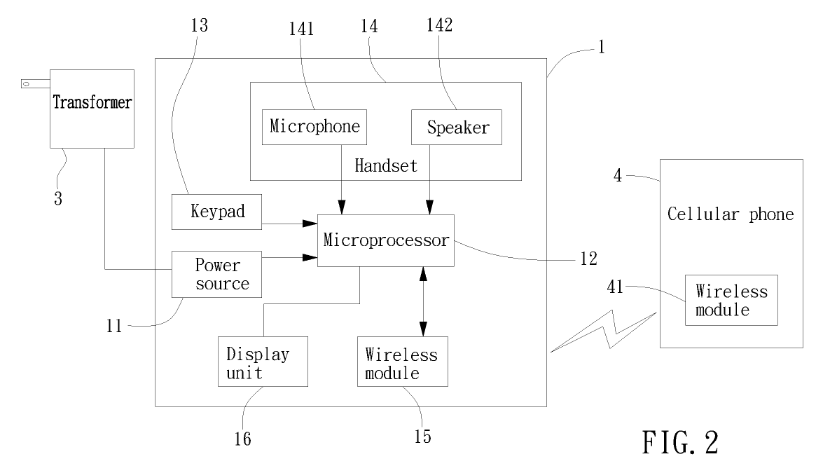

Please refer to FIG. 1 and FIG. 2, which are respective an architecture and a function block diagram of a PSTN phone according to a preferred embodiment of the invention. The PSTN telephone 1, having a plurality of extensions 2 connected thereto by a wired means or a wireless (RF) means, is adapted to a public switched telephone network (PSTN) while being enabled to pair with a mobile phone 4 having a wireless module 41 embedded therein, which is substantially the PSTN telephone embedded with a wireless module 15 capable of interfacing with the wireless module 41 of the mobile phone 4 so as to perform a vocal data exchange operation therebetween. Thereby, incoming calls/messages transmitted from a network used by the mobile phone 4 and those transmitted from the PSTN can be integrated and received by the use of the aforesaid PSTN telephone 1 or any of its extensions 2. In a preferred aspect, the wireless module can be a bluetooth module or a radio frequency (RF) module, which is capable of transmitting vocal data wirelessly; and the network system used by the mobile phone 4 can be a communication system selected from the group consisting of a PHS system, a GSM/DCS system, a CDMA system, a cdma2000 system, and a WCDMA system, however, other network system capable of supporting the mobile phone 4 can also be adopted thereby and thus are not limited thereby. As seen in FIG. 2, the PSTN telephone 1 is comprised of:
a power source 11, capable of providing power to the PSTN telephone 1 while being enable to connect to a transformer 3 for converting alternating current of a public power grid into direct current required by the PSTN telephone 1;
a microprocessor 12, capable of controlling and managing electrical signals of the PSTN telephone 1;
a keypad 13, capable of dialing;
a telephone transceiver 14, further comprising a microphone 141, capable of receiving vocal signals of a user, and a loudspeaker 142, capable of amplifying vocal signals received by the PSTN telephone 1;
a wireless module 15, coupled to the microprocessor 12, capable of matching to the wireless module 41 of the mobile phone 4 for enabling vocal signals to be transmitted between the same and the wireless module 41 of the mobile phone 4; and
a display unit 16, being substantially a liquid crystal display;
wherein, the wireless module 15 can be a bluetooth module or a RF module, being defined by a wireless communication protocol, such as IEEE 802.11.

From the above description, it is known that the PSTN telephone is adapted to a public switched telephone network (PSTN) while being enabled to communicate with a mobile phone, which is substantially the PSTN telephone embedded with a wireless module capable of interfacing with a bluetooth module of the mobile phone so as to perform a vocal data exchange operation therebetween, thereby, incoming calls/messages transmitted from the network used by the mobile phone and those transmitted from the PSTN can be integrated and received by the use of the aforesaid PSTN telephone or any of its extensions, and thus those incoming calls/messages will not be missed as one is failing to locate one's mobile phone. In addition, as the PSTN telephone is capable of enabling a person to use the PSTN telephone and any of its extension for receiving any incoming call of one's mobile phone, the person is prevented from contacting to the high electromagnetic wave during the instance of transmitting/receiving and thus the health of the person is well protected.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A PSTN telephone capable of receiving incoming calls of a mobile phone, being adapted to a public switched telephone network (PSTN) while being enabled to pair with the mobile phone having a wireless module embedded therein for performing a vocal data exchange therebetween, the PSTN telephone comprising:
a power source, capable of providing power to the PSTN telephone;
a microprocessor, capable of controlling and managing electrical signals of the PSTN telephone;
a telephone transceiver, further comprising:
a microphone, capable of receiving vocal signals of a user; and
a loudspeaker, capable of amplifying vocal signals received by the PSTN telephone; and
a wireless module, coupled to the microprocessor, capable of matching to the wireless module of the mobile phone for enabling vocal signals to be transmitted between the same and the wireless module of the mobile phone.

2. The PSTN telephone of claim 1, further comprising a display unit.

3. The PSTN telephone of claim 2, wherein the display unit is a liquid crystal display.

4. The PSTN telephone of claim 1, wherein the wireless module is a bluetooth module.

5. The PSTN telephone of claim 1, wherein the wireless module is radio frequency (RF) module.

6. The PSTN telephone of claim 5, wherein the transmission of the RF module is defined by IEEE 802.11 wireless communication protocol.

7. The PSTN telephone of claim 1, wherein the mobile phone is using a communication system selected from the group consisting of a PHS system, a GSM/DCS system, a CDMA system, a cdma2000 system and a WCDMA system.

8. The PSTN telephone of claim 1, wherein the power source is connected to a transformer for converting alternating current of a public power grid into direct current required by the PSTN telephone.

9. The PSTN telephone of claim 1, further comprising a plurality of extension, each being connected to the PSTN telephone by a means selected from the group consisting of a wireless means and a wired means.

10. The PSTN telephone of claim 9, wherein the wireless means is a radio frequency means.

11. The PSTN telephone of claim 1, further comprising a keypad for dialing.
